(19) United States
(12) Patent Application Publication
(10) Pub. No.: US 2009/0187701 A1
(43) Pub. Date: Jul. 23, 2009

(54) Nand flash memory access with relaxed timing constraints

(76) Inventor: Jin-Ki Kim, Kanata (CA)

Correspondence Address: Daniel A. Hammond;MOSAID Technologies Incorporated, 11 Hines Road, Kanata,Ontario, K2K 2X1, CA

(21) Appl. No.: 12/286,959

(22) Filed: Oct. 3, 2008

Related U.S. Application Data
(60) Provisional application No. 61/022,656, filed on Jan. 22, 2008.

(51) Int. Cl. G06F 12/02; G06F 12/00

(52) U.S. Cl. 711/103; 711/157; 711/E12.001; 711/E12.008

(57) ABSTRACT

Timing constraints on data transfers during access of a NAND flash memory can be relaxed by providing a plurality of data paths that couple the NAND flash memory to a buffer that provides external access to the memory. The buffer defines a bit width associated with the external access, and each of the data paths accommodates that bit width.

### RELATED APPLICATION

This application claims the priority of U.S. provisional patent application No. 61/022,656, filed on Jan. 22, 2008, the entire contents of which are incorporated herein by reference.

### FIELD

The invention relates generally to data processing and, more particularly, to data processing that uses flash memory for storing information.

### BACKGROUND

Conventional NAND flash memory technology provides high data storage density at relatively low cost. NAND flash memories are commonly used in numerous types of data processing applications, for example, mobile data processing applications and mobile data storage applications. Specific examples of applications that benefit from the use of NAND flash memory include digital audio/video players, cell phones, flash cards, USB flash drives and solid state drives (SSDs) for hard disk drive (HDD) replacement.

FIG. 1 diagrammatically illustrates a conventional NAND flash memory apparatus. In FIG. 1, a NAND flash memory cell array 10 contains n blocks (not explicitly shown), and each block contains m pages, one of which is shown. Some conventional NAND flash memory devices contain two such arrays. Each array (also referred to as a plane) is accessed on a page basis for both reading and programming operations. Each of the pages contains a data field that contains j bytes, and a spare field that contains k bytes, for a total of j+k bytes per page. In the memory plane shown in FIG. 1, j=4096 (i.e., 4 KB) and k=128, for a total of 4,224 bytes per page. In some conventional arrays, m=128 and n=2048.

During a page read operation, the selected page of data is loaded into the page buffer 13 of FIG. 1, and is then transferred, byte-wise sequentially via a one-byte wide signal path 17, into a one-byte wide I/O buffer 15. During a page program operation, the page data is transferred, byte-wise sequentially via signal path 17, from the I/O buffer 15 into the page buffer 13. (Sense amplifier and write driver arrangements conventionally positioned in the signal path 17 between the page buffer 13 and the I/O buffer 15 have been omitted in FIG. 1 to avoid unnecessary complexity.)

FIGS. 2 and 3 illustrate conventional examples of the timing of program (when signal W/R# is high) and read (W/R# low) operations, respectively. FIGS. 2 and 3 illustrate so-called double data rate (DDR) operations, wherein a byte (Din or Dout) of the page data is transferred (to or from the page buffer 13) on each rising and falling edge of a timing signal (designated as CLK in FIGS. 2 and 3). On the other hand, in conventional single data rate (SDR) approaches, the page data is transferred at a rate of one byte per cycle of CLK, achieving half the transfer throughput of the DDR approach of FIGS. 2 and 3. Some conventional approaches use a differential version of CLK as the timing signal for the read and program operations. In some conventional arrangements (for either a SDR or DDR interface), a write enable signal is used as the timing signal for programming operation, and a read enable signal is used as the timing signal for read operation.

Continuing with the example of DDR operation, an input data byte is valid at every half cycle of CLK during the programming operation of FIG. 2, which means the total time to transfer an input byte from the I/O buffer 15 to the page buffer 13 (see also FIG. 1) should be less than the half cycle time in order to meet the inherent timing requirements. This is also true for the read operation of FIG. 3, i.e., the total time for data sensing and transfer from the page buffer 13 to the I/O buffer 15 should be less than the half cycle time.

As the frequency of the timing signal (CLK in FIGS. 2 and 3) increases, the corresponding cycle time of the timing signal decreases. With such frequency increases, the time required for data to traverse the data input path from the I/O buffer 15 to the page buffer 13 (for programming operation), and the time required for data to traverse the data output path from the page buffer 13 to the I/O buffer 15 (for read operation) become bottlenecks, because the total time required (the timing budget) for traversing the data input path or the data output path cannot be easily reduced without measures such as for example, introducing high performance transistors, which may disadvantageously increase cost, including the chip cost.

Additionally, the data input and data output paths may become timing bottlenecks as the memory capacity increases, because an increase in memory capacity is typically accompanied by a corresponding increase in the physical distance between the page buffer 13 and the I/O buffer 15.

It is therefore desirable to provide for relaxation of constraints on the timing budget for data traversal of the interface between the page buffer and the I/O buffer in a NAND flash memory apparatus.

### BRIEF DESCRIPTION OF THE DRAWINGS

FIG. 1 diagrammatically illustrates a NAND flash memory apparatus according to the prior art.

FIGS. 2 and 3 graphically illustrate the timing of prior art memory programming operation and memory read operation, respectively.

FIG. 4 diagrammatically illustrates a data processing system according to example embodiments of the invention.

FIGS. 5 and 6 graphically illustrate memory programming operations and memory read operations, respectively, that can be performed by the system of FIG. 4.

FIG. 7 diagrammatically illustrates a portion of FIG. 4 according to example embodiments of the invention.

FIGS. 8 and 9 graphically illustrate operations that can be performed by the embodiments of FIG. 7.

FIG. 10 diagrammatically illustrates a data processing system according to further example embodiments of the invention.

FIGS. 11 and 12 graphically illustrate memory programming operations and memory read operations, respectively, that can be performed by the system of FIG. 10.

FIG. 13 diagrammatically illustrates a data processing system according to further example embodiments of the invention.

FIG. 14 diagrammatically illustrates a data processing system according to further example embodiments of the invention.

### DETAILED DESCRIPTION

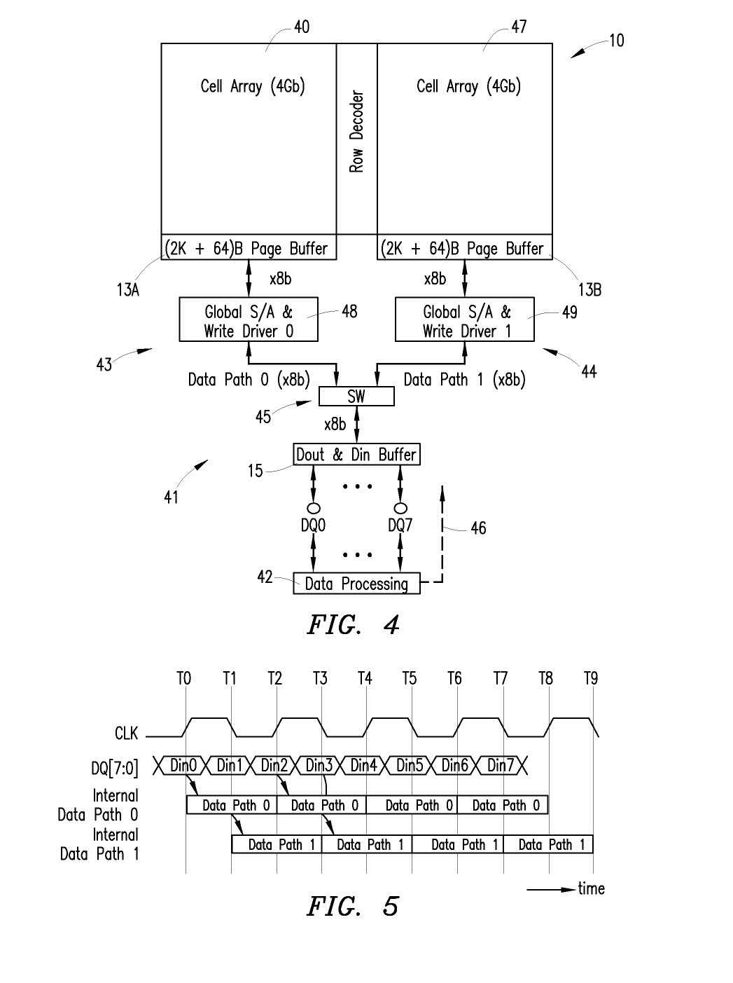

FIG. 4 diagrammatically illustrates a data processing system according to example embodiments of the invention. The data processing system includes a NAND flash memory apparatus 41 coupled to a data processing resource 42. In some embodiments, the memory apparatus 41 relaxes the aforementioned timing constraints associated with data transfers between the page buffer 13 and the I/O buffer 15 in the conventional apparatus of FIG. 1. This is achieved in some embodiments by dividing the page buffer 13 of FIG. 1 into a plurality of page buffer portions, such as page buffer portions 13A and 13B of FIG. 4. In some embodiments, the page buffer portions 13A and 13B are implemented as physically distinct buffers that define the constituent portions of an overall composite page buffer. In some embodiments, the page buffer portions 13A and 13B are simply constituent portions of an overall composite page buffer that is a single physical buffer.

In the example memory apparatus 41 of FIG. 4, the page buffer portions 13A and 13B each represent one-half of the overall page buffer. Each of the page buffer portions thus has a j/2-byte data field and a k/2-byte spare field. The page buffer portions 13A and 13B are coupled to respectively corresponding portions (e.g., halves) 40 and 47 of a NAND flash memory plane, such as the conventional NAND flash memory plane 10 of FIG. 1.

For purposes of exposition only, the NAND flash memory plane 10 is hereinafter assumed to be an 8 G-bit plane corresponding to the aforementioned conventional example wherein j=4096, k=m=128, and n=2048. If each of the page buffer portions 13A and 13B represents one-half of the overall page buffer 13 of FIG. 1, then each page buffer portion 13A and 13B has a 2,048-byte (i.e., 2 KB) data field and a 64-byte spare field. If each of the memory plane portions 40 and 47 constitutes one-half of the plane 10, then each of the NAND flash memory plane portions 40 and 47 is a 4 G-bit NAND flash cell array within the 8 G-bit plane 10.

The page buffer portions 13A and 13B have associated therewith respectively corresponding signal paths 43 and 44 (also designated in FIG. 4 as data path 0 and data path 1, respectively) that transfer data (or other information such as program code/instructions) between their associated page buffer portions and the I/O buffer 15. Each of the signal paths is eight bits (one byte) wide, thereby matching the conventional bit width of the I/O buffer 15 (see also FIG. 1). The signal paths 43 and 44 include respective sets 48 and 49 of sense amplifiers and write drivers (also designated in FIG. 4 as global S/A & write driver 0 and global S/A & write driver 1, respectively). The memory apparatus 41 of FIG. 4 thus contains two eight-bit wide sets of sense amplifiers and write drivers, whereas the conventional apparatus of FIG. 1 contains only a one such set of sense amplifiers and write drivers (not explicitly shown in FIG. 1).

A switching arrangement (SW), designated generally at 45, interfaces the eight-bit wide signal paths 43 and 44 to the eight-bit (DQ0-DQ7) I/O buffer 15, such that both signal paths 43 and 44 are available to the data processing resource 42 for both memory read operation and memory program operation. The data processing resource 42 provides control signaling, designated generally at 46, to control the read and program operations. The control signaling at 46 includes the control signals used to control the conventional memory read and program operations described above with respect to FIGS. 1-3, as well as additional control signaling to control operation of the switching arrangement 45. The data processing resource 42 further provides (in conventional fashion) a sequence of input data bytes at the DQ0-DQ7 terminals of the I/O buffer 15 during a memory program operation, and receives (in conventional fashion) a sequence of output data bytes from the DQ0-DQ7 terminals during a memory read operation.

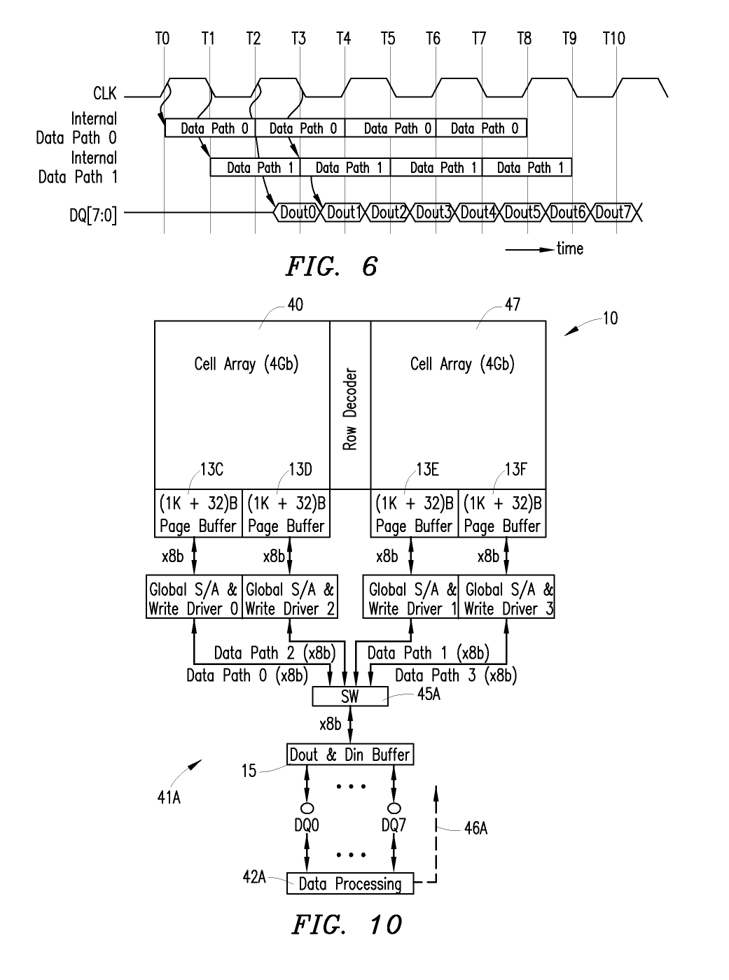

FIGS. 5 and 6 graphically illustrate data transfer timing for DDR programming and read operations, respectively, according to example embodiments of the invention. In some embodiments, the system of FIG. 4 is capable of performing the programming and read operations of FIGS. 5 and 6. For the programming operation shown in FIG. 5, the switching arrangement 45 of FIG. 4 operates such that the data bytes Din0, Din1, etc. in the input sequence provided by the data processing resource 42 are alternatingly routed on the signal paths 43 and 44 (data path 0 and data path 1) to the respectively corresponding memory portions 40 and 47 of the memory plane 10. The first byte Din0 is latched into the I/O buffer 15 on the rising edge (T0) of CLK, for transfer to the page buffer portion 13A via the signal path 43 (data path 0). The second byte Din1 is latched on the falling edge (T1) of CLK, for transfer to the page buffer portion 13B via the signal path 44 (data path 1). The third byte Din2 is latched on the next rising edge (T2) of CLK, for transfer to the page buffer portion 13A via the signal path 43, the fourth byte Din3 is latched on the next falling edge (T3) of CLK, for transfer to the page buffer portion 13B via the signal path 44, and so on.

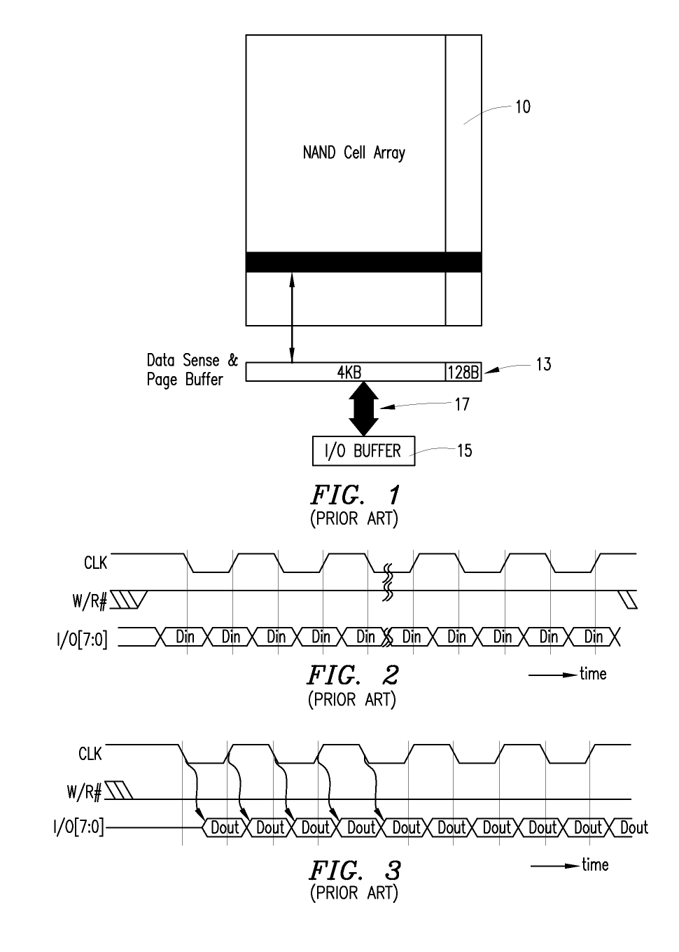

With this alternating (or interleaved) selection of the signal paths 43 and 44, the timing budget for transfers from the I/O buffer 15 to the page buffer portions 13A and 13B is relaxed relative to the timing budget (shown in FIG. 2) for transfers from the I/O buffer 15 to the page buffer 13 of FIG. 1. In FIG. 5, although a byte of data is latched on every edge of CLK as in FIG. 2, the total timing budget for transfers from the I/O buffer 15 to the page buffer portions 13A and 13B is one full cycle of CLK, rather than the one-half CLK cycle timing budget associated with the conventional approach of FIGS. 1 and 2. Consider, for example, the programming sequence Din0, Din1, Din2. Due to the interleaved selection of the signal paths 43 and 44, the transfer of Din0 through signal path 43 to page buffer portion 13A need not be complete when Din1 is latched into the I/O buffer 15 at T1. Rather, the signal path 43 just needs to be available when Din 2 is latched into the I/O buffer 15 at T2.

FIG. 6 shows graphically that the timing budget for memory read operation is likewise relaxed. At rising CLK edge T0, the first byte Dout0 is output from page buffer portion 13A to the signal path 43 (data path 0) for transfer to the I/O buffer 15. The byte Dout0 is valid in the I/O buffer 15 in response to CLK rising edge T2. The latency of one CLK cycle corresponds to the time required for transfer from page buffer portion 13A to I/O buffer 15. Similarly, at falling CLK edge T1, the next byte Dout1 is output from page buffer portion 13B to the signal path 44 (data path 1) for transfer to the I/O buffer 15. The byte Dout1 is valid in the I/O buffer 15 in response to falling CLK edge T3.

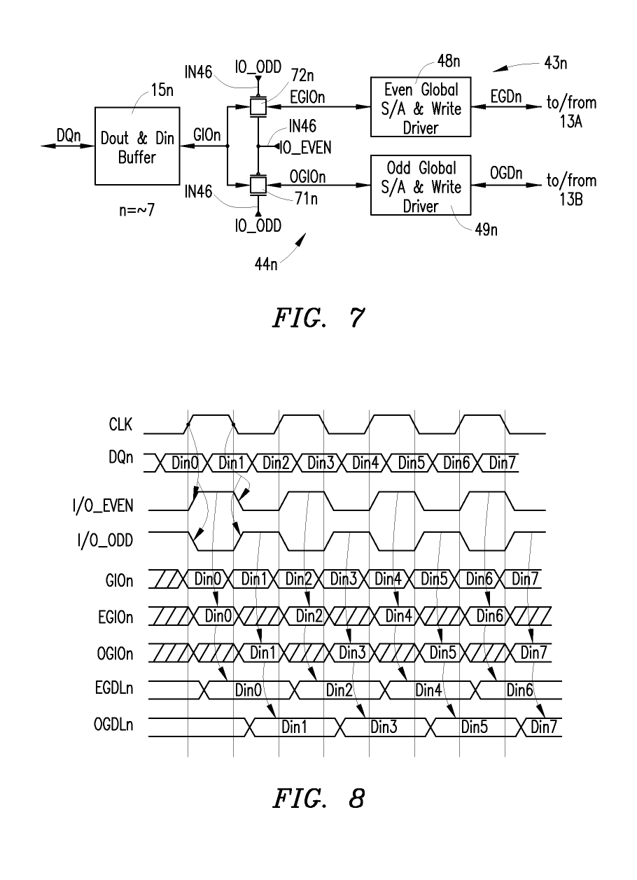

In some embodiments, the switching arrangement 45 implements a multiplexing function that multiplexes data bytes from the signal paths 43 and 44 into the I/O buffer 15 during read operation, and a de-multiplexing function that de-multiplexes data bytes from the I/O buffer 15 onto the signal paths 43 and 44 during programming operation. FIGS. 7-9 illustrate an example of such a switching arrangement.

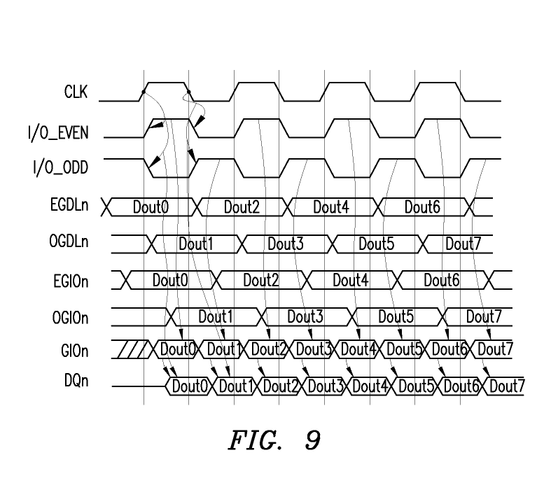

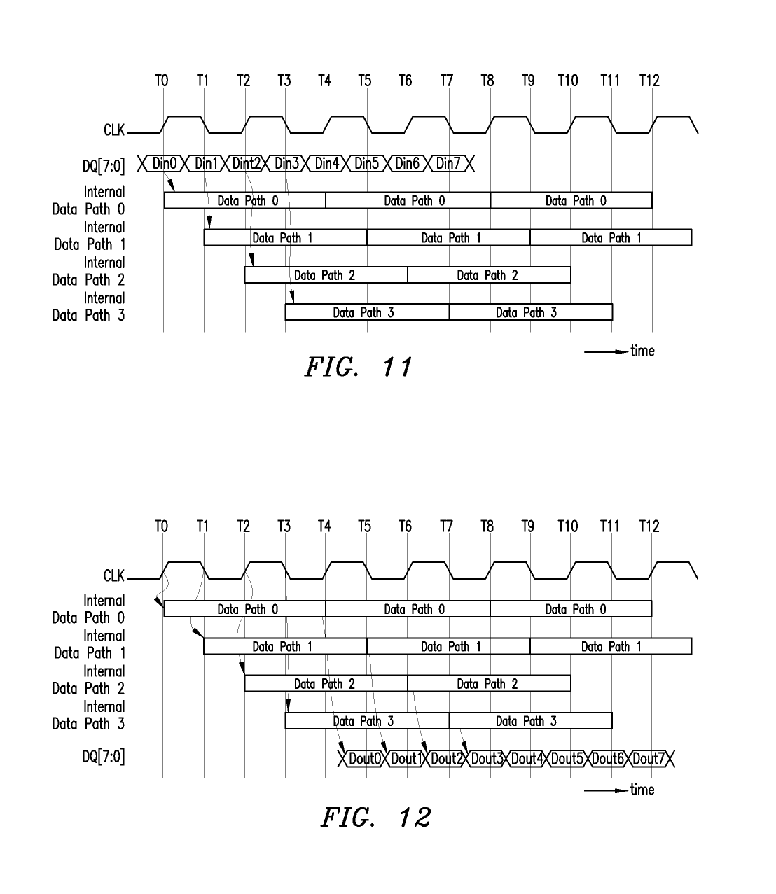

More specifically, FIGS. 7-9 illustrate the de-multiplexing of the nth bit location GIOn of the I/O buffer 15 onto the signal paths 43 and 44 for memory programming (shown in FIG. 8), and the multiplexing of bits from the page buffers 13A and 13B into the nth bit location GIOn for memory reading (shown in FIG. 9). In FIG. 7, reference numerals from FIG. 4 are shown with the suffix ‘n’ to indicate structures that represent the nth bit of the corresponding byte-wide structures shown in FIG. 4. For the byte-wide architecture example shown in FIG. 4, n takes the values 0, 1, . . . 7. The switching control signals IO_ODD and IO_EVEN of FIG. 7 are provided globally for all eight bits (n=0, 1, . . . 7) of the byte-wide architecture of FIG. 4.

The even-numbered bytes (Din0/Dout0, Din 2/Dout2, Din 4/Dout4 and Din 6/Dout6) in a read or programming sequence travel on signal path 43, so EGIOn and EGDLn correspond to the nth bit of a given even-numbered byte. Similarly, the odd-numbered bytes (Din1/Dout1, Din3/Dout3, Din5/Dout5 and Din7/Dout7) in a read or programming sequence travel on signal path 44, so OGIOn and OGDLn correspond to the nth bit of a given odd-numbered byte. The data processing resource 42 provides the switching control signals IO_ODD and IO_EVEN (see also 46 in FIG. 4). Referring also to FIGS. 8 and 9, the switching control signals IO_ODD and IO_EVEN control pass gates 71n and 72n appropriately to implement multiplexing for the read operation of FIG. 8, and de-multiplexing for the programming operation of FIG. 9.

FIG. 10 diagrammatically illustrates a data processing system according to further example embodiments of the invention. The system of FIG. 10, generally similar to that of FIG. 4, includes a NAND flash memory apparatus 41A coupled to a data processing resource 42A. In FIG. 10, however, four eight-bit wide signal paths (data path 0-data path 3) are provided for transferring data bytes between the I/O buffer 15 and the memory portions 40 and 47. In FIG. 10, the page buffer portion 13A of FIG. 4 is replaced by a set of two page buffer portions 13C and 13D, each of which accounts for one-half of the page buffer portion 13A. Also in FIG. 10, the page buffer portion 13B of FIG. 4 is replaced by a set of two page buffer portions 13E and 13F, each of which accounts for one-half of the page buffer portion 13B. In some embodiments, each of the signal paths, data path 0-data path 3, has generally the same structural and functional characteristics as the signal paths 43 and 44 of FIG. 4.

A switching arrangement 45A interfaces the four signal paths to the I/O buffer 15. The data processing resource 42A provides the input sequence of data bytes during programming operations, receives the output sequence of data bytes during read operations, and provides control signaling 46A that is generally similar to the control signaling 46 of FIG. 4, but includes control signals that cause the switching arrangement 45A appropriately to interface the four signal paths to the I/O buffer 15.

FIGS. 11 and 12 graphically illustrate data transfer timing for DDR programming and read operations, respectively, according to example embodiments of the invention. In some embodiments, the system of FIG. 10 is capable of performing the programming and read operations of FIGS. 11 and 12. In FIG. 11, as in FIG. 5, a data byte is loaded into the I/O buffer 15 on each edge of CLK. The control signaling 46A (see also FIG. 10) causes the switching arrangement 45A to interleave the selection of the four signal paths in order to route the data bytes of the input sequence as follows: Din0 to page buffer portion 13C via data path 0; Din1 to page buffer portion 13E via data path 1; Din 2 to page buffer portion 13D via data path 2; and Din 3 to page buffer portion 13F via data path 3. This represents a four-way interleaving of the selection of the four signal paths, data path 0-data path 3.

As compared to the two-way interleaving of signal path selection described above with respect to FIGS. 4-6, the four-way interleaving of FIGS. 10-12 further relaxes the timing budget for transfers between the I/O buffer 15 and the page buffer portions. For example, as shown in FIG. 11, Din0 is latched into the I/O buffer 15 at T0, and is routed onto data path 0, but data path 0 need not be available for another data transfer until Din 4 is latched at T4. Thus, two full cycles of CLK are available for transferring a data byte from the I/O buffer 15 to any of the page buffer portions 13C-13F, although a new byte is latched into the I/O buffer 15 on every edge of CLK. Likewise, FIG. 12 illustrates that the same two CLK cycle timing budget is also realized during the memory read operation, while still outputting a data byte from one of the page buffer portions 13C-13F on every edge of CLK.

As will be evident to workers in the art (and as implemented in some embodiments), the pass gate structure and control signals of FIG. 7 are readily extended to implement the programming and read operations respectively shown FIGS. 11 and 12.

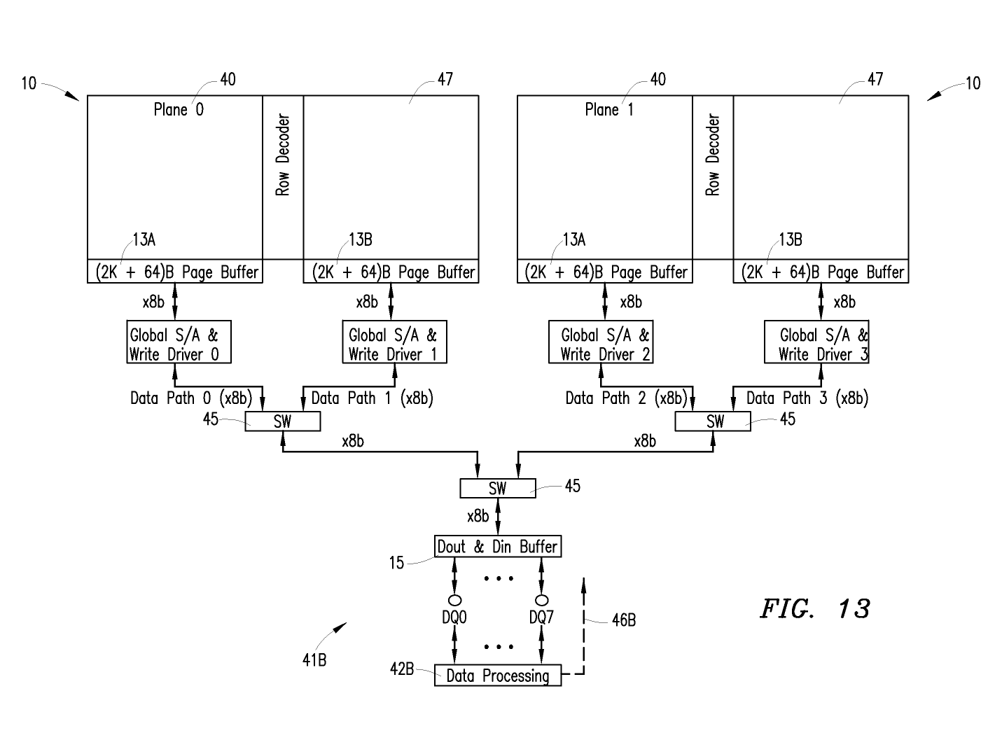

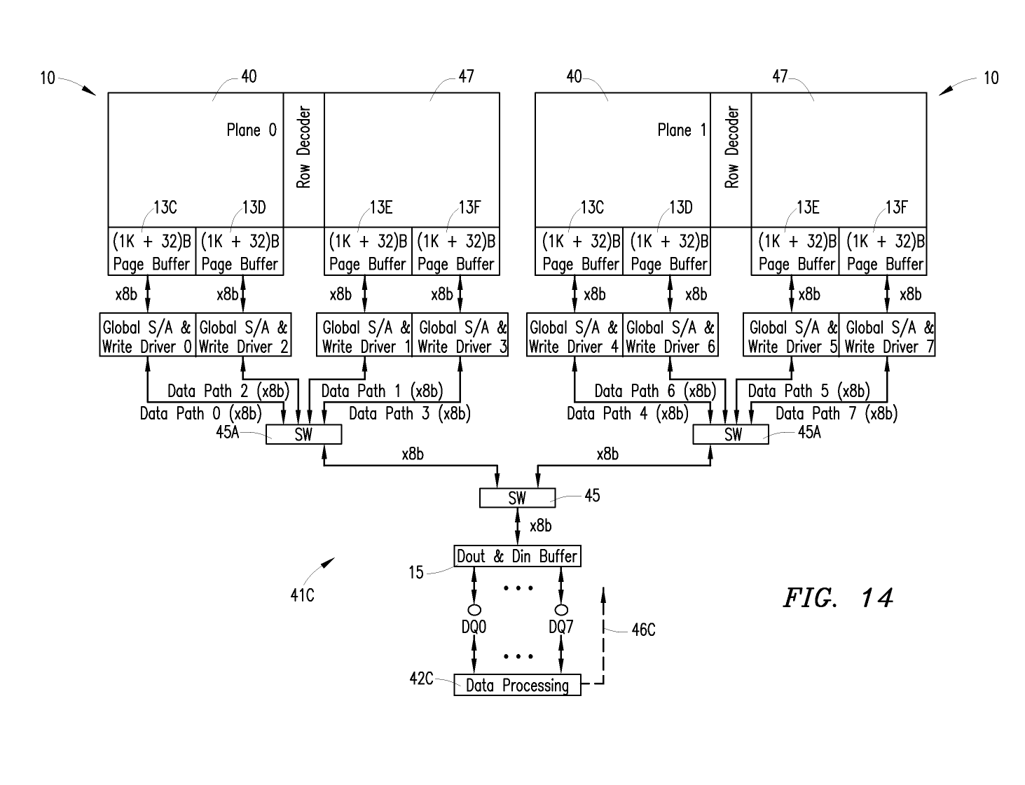

FIG. 13 diagrammatically illustrates a data processing system according to further example embodiments of the invention. The data processing system of FIG. 13 can be seen as an extension of the data processing system of FIG. 4 to include two memory planes 10. More specifically, the system includes a memory apparatus 41B having two NAND flash memory planes 10, also designated as Plane 0 and Plane 1. Each of the memory planes is interfaced to the I/O buffer 15 via two page buffer portions (13A and 13B) and two respectively corresponding signal paths (data path 0 and data path 1 for Plane 0, and data path 2 and data path 3 for Plane 1), in the same fashion as described above with respect to FIGS. 4-6. Plane 0 and Plane 1 have associated therewith first and second respectively corresponding instances of the switching arrangement 45 (see also FIGS. 4-6), which interface their associated signal paths with respect to the I/O buffer 15 in the same fashion as described above with respect to FIGS. 4-6. A third instance of the switching arrangement 45 is provided to interface the first and second switching arrangements 45 to the I/O buffer 15.

A data processing resource 42B provides control signaling 46B to the memory apparatus 41B, including signals that control the first and second instances of switching arrangement 45 in the same fashion as described with respect to FIGS. 4-6. Further control signaling at 46B controls a third instance of the switching arrangement 45 such that (read or program) accesses of Plane 0 and Plane 1 are interleaved with one another according to any desired timing.

FIG. 14 diagrammatically illustrates a data processing system according to further example embodiments of the invention. The data processing system of FIG. 14 can be seen as an extension of the data processing system of FIG. 10 to include two memory planes 10 (contained within a memory apparatus 41C), in generally the same fashion that the data processing system of FIG. 13 extends the data processing system of FIG. 4 to include two memory planes. A data processing resource 42C provides control signaling 46C to the memory apparatus 41C, including signals that control first and second instances of the switching arrangement 45A (see also FIGS. 10-12) in the same fashion as described with respect to FIGS. 10-12. Further control signaling at 46C controls an instance of the switching arrangement 45 (see also FIGS. 4-6) such that (read or program) accesses of Plane 0 and Plane 1 are interleaved with one another according to any desired timing.

Various embodiments of the data processing systems described above exhibit characteristics such as the following non-exhaustive list of examples: (1) the data processing system is provided as a single integrated circuit; (2) the memory apparatus and the data processing resource are respectively provided on two separate integrated circuits; (3) one of the memory apparatus and the data processing resource is provided on a single integrated circuit, and the other of the memory apparatus and the data processing resource is distributed across a plurality of integrated circuits; (4) the memory apparatus is distributed across a plurality of integrated circuits, and the data processing resource is distributed across a plurality of integrated circuits; (5) the read and programming operations are timed according to a differential version of CLK; (6) programming operations are timed according to a write enable signal (instead of CLK), and read operations are timed according to a read enable signal (instead of CLK); and (7) the architecture of the data processing system is scaled for transfer of data units having bit widths other than eight bits.

Although the NAND flash memory apparatus shown in FIGS. 13 and 14 contains two memory planes, in other embodiments the NAND flash memory apparatus contains more than two memory planes. In some embodiments, the NAND flash memory apparatus consists of a number of memory planes that is greater than two, and is not a power of two. For example, in various embodiments, the NAND flash memory apparatus consists of three memory planes whose contents are interfaced to a single I/O buffer according to interleaved selection sequences analogous to those described above with respect to FIGS. 13 and 14.

In some embodiments, the various data processing systems described above implement mobile data processing applications or mobile data storage applications. In various embodiments, the data processing systems described above constitute any one of, for example, digital audio/video players, cell phones, flash cards, USB flash drives and solid state drives (SSDs) for hard disk drive (HDD) replacement.

Although example embodiments of the invention have been described above in detail, this does not limit the scope of the invention, which can be practiced in a variety of embodiments.

What is claimed is:

1. A memory apparatus, comprising:
a NAND flash memory;
a buffer that provides external access to said NAND flash memory and defines a bit width associated with said external access;
first and second data paths coupling said NAND flash memory to said buffer, each of said first and second data paths accommodating said bit width; and
a switching arrangement coupled to said NAND flash memory and said buffer, said first and second data paths traversing said switching arrangement, and said switching arrangement configured to select said first and second data paths in alternating sequence.

2. A memory apparatus, comprising:
a NAND flash memory;
a buffer that provides external access to said NAND flash memory and defines a bit width associated with said external access; and
a plurality of data paths coupling said NAND flash memory to said buffer, each of said data paths accommodating said bit width.

3. The apparatus of claim 2, including a composite buffer having a plurality of constituent buffer portions that are coupled to associated portions of said NAND flash memory and are further coupled to respectively corresponding ones of said data paths.

4. The apparatus of claim 3, wherein said portions of said NAND flash memory are contained within a single plane of said NAND flash memory.

5. The apparatus of claim 3, wherein said portions of said NAND flash memory are provided across a plurality of planes of said NAND flash memory.

6. The apparatus of claim 2, including a switching arrangement coupled to said NAND flash memory and said buffer, said data paths traversing said switching arrangement, and said switching arrangement configured to select said data paths according to a selection sequence.

7. The apparatus of claim 6, including first and second sets of said data paths respectively coupled to first and second portions of said NAND flash memory.

8. The apparatus of claim 7, wherein said first and second portions of said NAND flash memory are contained within a single plane of said NAND flash memory.

9. The apparatus of claim 7, wherein said first and second portions of said NAND flash memory are provided in respectively different planes of said NAND flash memory.

10. The apparatus of claim 9, wherein said NAND flash memory consists of a number of said planes that is a power of two.

11. The apparatus of claim 7, wherein said selection sequence temporally interleaves selections of said data paths in said first set with selections of said data paths in said second set.

12. The apparatus of claim 6, including first, second, third and fourth sets of said data paths respectively coupled to first, second, third and fourth portions of said NAND flash memory.

13. The apparatus of claim 12, wherein said first, second, third and fourth portions of said NAND flash memory are provided across a plurality of planes of said NAND flash memory.

14. The apparatus of claim 13, wherein said plurality of planes consists of a number of said planes that is a power of two.

15. The apparatus of claim 12, wherein said selection sequence includes a first interleaving that temporally interleaves selections of said data paths in said first set with selections of said data paths in said second set, and further includes a second interleaving that temporally interleaves selections of said data paths in said third set with selections of said data paths in said fourth set.

16. The apparatus of claim 15, wherein said selection sequence further includes a third interleaving that temporally interleaves selection of said first interleaving with selection of said second interleaving.

17. The apparatus of claim 6, wherein selections of said data paths are temporally interleaved in said selection sequence.

18. The apparatus of claim 6, wherein said switching arrangement multiplexes information from said data paths into said buffer during a read access of said NAND flash memory, and de-multiplexes information from said buffer onto said data paths during a write access of said NAND flash memory.

19. The apparatus of claim 2, wherein each of first and second said data paths is configured to carry information while the other of said first and second data paths is also carrying information.

20. A data processing system, comprising:
a data processor; and
a memory apparatus coupled to said data processor, said memory apparatus including a NAND flash memory, a buffer that permits said data processor to access to said memory apparatus and defines a bit width associated with said access, and a plurality of data paths coupling said NAND flash memory to said buffer, each of said data paths accommodating said bit width.

21. The system of claim 20, wherein each of first and second said data paths is configured to carry information while the other of said first and second data paths is also carrying information.

22. The system of claim 20, wherein said memory apparatus includes a switching arrangement coupled to said NAND flash memory and said buffer, said data paths traversing said switching arrangement, and said switching arrangement configured to select said data paths according to a selection sequence.

23. The system of claim 22, wherein said memory apparatus includes first and second sets of said data paths that are respectively coupled to first and second portions of said NAND flash memory.

24. The system of claim 23, wherein said selection sequence temporally interleaves selections of said data paths in said first set with selections of said data paths in said second set.

25. The system of claim 22, wherein said memory apparatus includes first, second, third and fourth sets of said data paths that are respectively coupled to first, second, third and fourth portions of said NAND flash memory.

26. The system of claim 25, wherein said selection sequence includes a first interleaving that temporally interleaves selections of said data paths in said first set with selections of said data paths in said second set, and further includes a second interleaving that temporally interleaves selections of said data paths in said third set with selections of said data paths in said fourth set.

27. The system of claim 26, wherein said selection sequence further includes a third interleaving that temporally interleaves selection of said first interleaving with selection of said second interleaving.

28. The system of claim 22, wherein selections of said data paths are temporally interleaved in said selection sequence.

29. The system of claim 22, wherein said switching arrangement multiplexes information from said data paths into said buffer during a read access of said NAND flash memory, and de-multiplexes information from said buffer onto said data paths during a write access of said NAND flash memory.

30. The system of claim 20, wherein said memory apparatus includes a composite buffer having a plurality of constituent buffer portions that are coupled to associated portions of said NAND flash memory and are further coupled to respectively corresponding ones of said data paths.

31. The system of claim 30, wherein said constituent buffer portions are respective buffers that are physically distinct from one another.

32. The system of claim 20, provided as a mobile data processing system.

33. The system of claim 20, provided as one of a digital audio player, a digital video player, a cell phone, a flash card, a USB flash drive, and a solid state drive for hard disk drive replacement

34. The system of claim 20, wherein said bit width is eight bits.

35. A method of transferring data units between a NAND flash memory and a buffer that provides external access to the NAND flash memory and defines a bit width of the data units, comprising:
providing a sequence of the data units: and
routing data units that are adjacent in the sequence on respectively different data paths provided between the NAND flash memory and the buffer, wherein each of the data paths accommodates said bit width.
